(19) United States
(12) Patent Application Publication
(10) Pub. No.: US 2014/0152622 A1
(43) Pub. Date: Jun. 5, 2014

(54) INFORMATION PROCESSING APPARATUS, INFORMATION PROCESSING METHOD, AND COMPUTER READABLE STORAGE MEDIUM

(71) Applicant: Kabushiki Kaisha Toshiba, Tokyo (JP)

(72) Inventor: Kentaro Takeda, Suginami-ku (JP)

(73) Assignee: Kabushiki Kaisha Toshiba, Tokyo (JP)

(21) Appl. No.: 14/013,986

(22) Filed: Aug. 29, 2013

(30) Foreign Application Priority Data
Nov. 30, 2012 (JP) 2012-263403

(51) Int. Cl. G06F 3/042

(52) U.S. Cl. CPC G06F 3/0426
USPC 345/175

(57) ABSTRACT

An information processing apparatus includes an imaging device, a keyboard detector, a first input detector, and a display. The keyboard detector is configured to detect a virtual keyboard based on an image captured by the imaging device. The first input detector is configured to detect an input to the virtual keyboard based on the captured image. The display is configured to display information corresponding to the input detected by the first input detector.

### CROSS-REFERENCE TO RELATED APPLICATION(S)

The present disclosure claims priority to Japanese Patent Application No. 2012-263403, filed on Nov. 30, 2012, which is incorporated herein by reference in its entirety.

### FIELD

Embodiments described herein relate generally to an information processing apparatus, an information processing method, and a computer readable storage medium.

### BACKGROUND

Portable information processing apparatus each provided with a touch panel on a display screen and having an information input function through the touch panel, such as tablet PCs (personal computers), are now in wide use. Such information processing apparatus are required to be manipulated through an external device connected thereto and to be input desired information from the connected external device.

However, to always carry an external device (e.g., a keyboard) together with such an information processing apparatus for the purpose of using the information processing apparatus is cumbersome and may lower user's convenience.

### BRIEF DESCRIPTION OF THE DRAWINGS

FIG. 1 is a perspective view showing an external structure of an information processing apparatus according to an embodiment;

FIG. 2 illustrates an example of a use form of the information processing apparatus according to the embodiment;

FIG. 3 shows the schematic configuration of a main part of the information processing apparatus according to the embodiment;

FIG. 4 is a flowchart showing how a virtual keyboard detection program operates when run on the information processing apparatus according to the embodiment;

FIG. 5 is a flowchart showing a first detection method which is performed in the information processing apparatus according to the embodiment;

FIG. 6 is a table showing an example of an identification mark database which is stored in the information processing apparatus according to the embodiment;

FIG. 7 is a table showing an example of a virtual keyboard image database which is stored in the information processing apparatus according to the embodiment;

FIG. 8 illustrates how an identification mark is printed on a medium by the information processing apparatus according to the embodiment;

FIG. 9 is a flowchart showing a second detection method which is performed in the information processing apparatus according to the embodiment;

FIGS. 10A and 10B are diagrams for explaining a reference image which is used in detection of a virtual keyboard in the information processing apparatus according to the embodiment;

FIG. 11 shows an example of a screen which is presented by the information processing apparatus according to the embodiment to prompt a user to print the virtual keyboard;

FIG. 12 shows boundary marks which are printed on a medium by the information processing apparatus according to the embodiment;

FIG. 13 is a flowchart of a process for detecting a non-inputtable state which is executed by the information processing apparatus according to the embodiment;

FIG. 14 is a table showing an example of the virtual keyboard image database which is stored in the information processing apparatus according to the embodiment;

FIG. 15 shows an example of a key correspondence table which is stored in the information processing apparatus according to the embodiment;

FIGS. 16A to 16C show an example of display patterns of an indicator which is displayed on the information processing apparatus according to the embodiment;

FIG. 17 is a flowchart showing how an input detection program operates when run on the information processing apparatus according to the embodiment;

FIGS. 18A and 18B show examples of hand shape image databases which are stored in the information processing apparatus according to the embodiment; and

FIG. 19 is a flowchart showing how a position deviation detection program operates when run on the information processing apparatus according to the embodiment.

### DETAILED DESCRIPTION

According to one embodiment, an information processing apparatus includes an imaging module, a keyboard detector, a first input detector, and a display. The keyboard detector is configured to detect a virtual keyboard based on an image captured by the imaging module. The first input detector is configured to detect an input to the virtual keyboard based on the captured image. The display is configured to display information corresponding to the input detected by the first input detector.

Embodiments will be described in detail with reference to the accompanying drawings.

### (Embodiments)

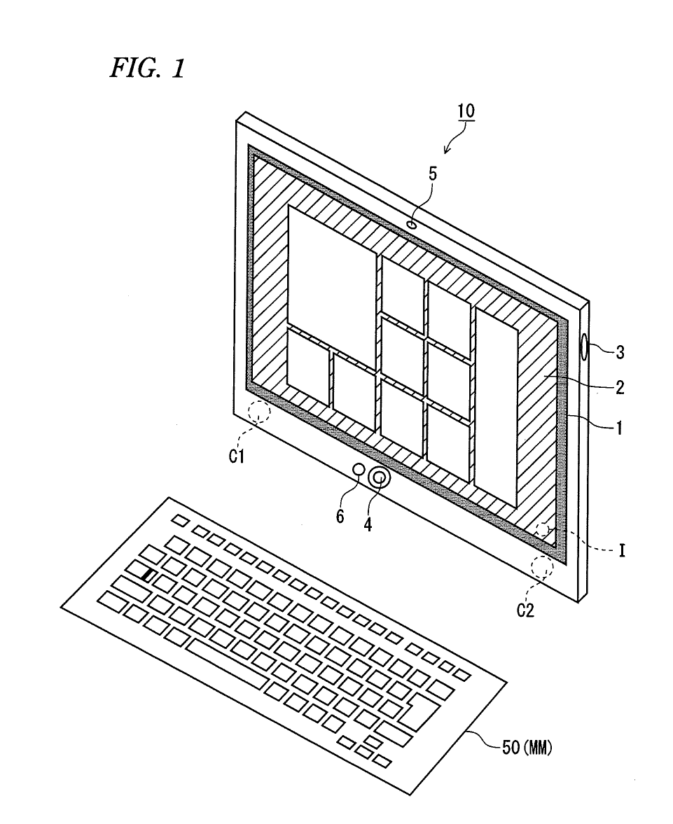

FIG. 1 is a perspective view showing an external structure of an information processing apparatus 10 according to this embodiment. The information processing apparatus 10 is a slate PC, a tablet PC (a display apparatus having a software keyboard function), a TV receiver, a smartphone, a cell phone, or the like.

As shown in FIG. 1, the information processing apparatus 10 is equipped with an LCD (liquid crystal display) 1, a power switch 3, a camera 4, a microphone 5, and an illuminance sensor 6.

The LCD 1 is a liquid crystal display device and functions as a display module configured to display information corresponding to inputs that are detected by an input detecting module.

The top surface of the LCD 1 is provided with a transparent touch panel 2. The LCD 1 and the touch panel 2 constitute a touch screen display. The touch panel 2 is of a resistive film type, a capacitance type, or the like and detects a contact position of a finger, a pen, or the like on the display screen. A user can cause the information processing apparatus 10 to perform desired processing (input of information) by manipulating the touch panel 2 (touching the touch panel 2 with his or her finger, for example).

The power switch 3 is provided so as to be exposed on a cabinet surface of the information processing apparatus 10, and receives a manipulation for powering on or off the information processing apparatus 10.

The camera 4, which is an imaging module, shoots a subject that is located in an angle of view.

The microphone 5 picks up sound generated outside the information processing apparatus 10 and functions as a sound detecting module.

The illuminance sensor 6 is a sensor that detects brightness around the information processing apparatus 10. The illuminance sensor 6 is provided near the camera 4 and functions as a brightness detecting module that detects brightness around the camera 4 (the imaging module).

The positions of the power switch 3, the camera 4, the microphone 5, and the illuminance sensor 6 on the information processing apparatus 10 are not limited to the ones shown in FIG. 1. The positions of the power switch 3, etc. may be changed taking into consideration the user's convenience, a use form of the information processing apparatus 10, and other factors.

As shown in FIG. 1, a virtual keyboard 50 is disposed in front of the information processing apparatus 10. Unlike ordinary keyboards, the virtual keyboard 50 is not a dedicated hardware. The virtual keyboard 50 is, for example, an image of plural keys (keyboard) printed on a medium MM such as paper and is a virtual thing.

The virtual keyboard 50 is used to manipulate the information processing apparatus 10, input information thereto, and the like. A user can input information to the information processing apparatus 10 using the virtual keyboard 50. At this time, the user need not connect the virtual keyboard 50 to the information processing apparatus 10 physically using a connector or the like or by near field connection using electromagnetic waves.

Although described in detail later, more specifically the information processing apparatus 10 recognizes manipulation of each key of the virtual keyboard 50 by shooting the virtual keyboard 50 with the camera 4 and detecting a change in shot images.

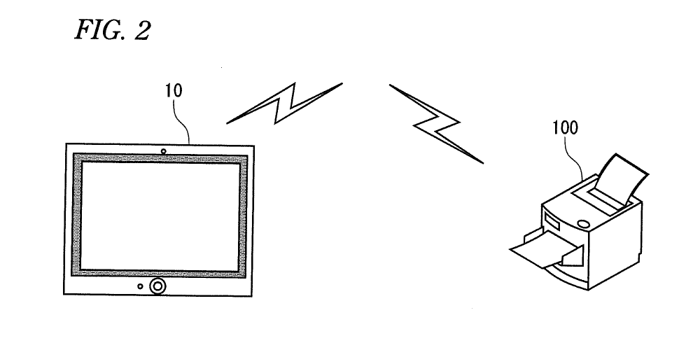

For example, as shown in FIG. 2, the information processing apparatus 10 can wirelessly communicate with a printing device 100 that prints on a paper medium, over a wireless communication line using a communication function (which will be described later). As a result, when necessary, a user can cause the printing device 100 to output a paper medium on which the virtual keyboard 50 is printed, by a communication between the information processing apparatus 10 and the printing device 100 via the wireless communication line. As a result, the user is not required to carry an external device together with the information processing apparatus 10, which is convenient to the user.

The medium MM on which the virtual keyboard 50 is to be printed is not limited to paper but may be a plate-like plastic member or the like. The medium MM may be made of any material and have any shape so long as it allows keys (an input interface) of the keyboard to be drawn (e.g., printed) or displayed thereon.

### <Configuration of Information Processing Apparatus 10>

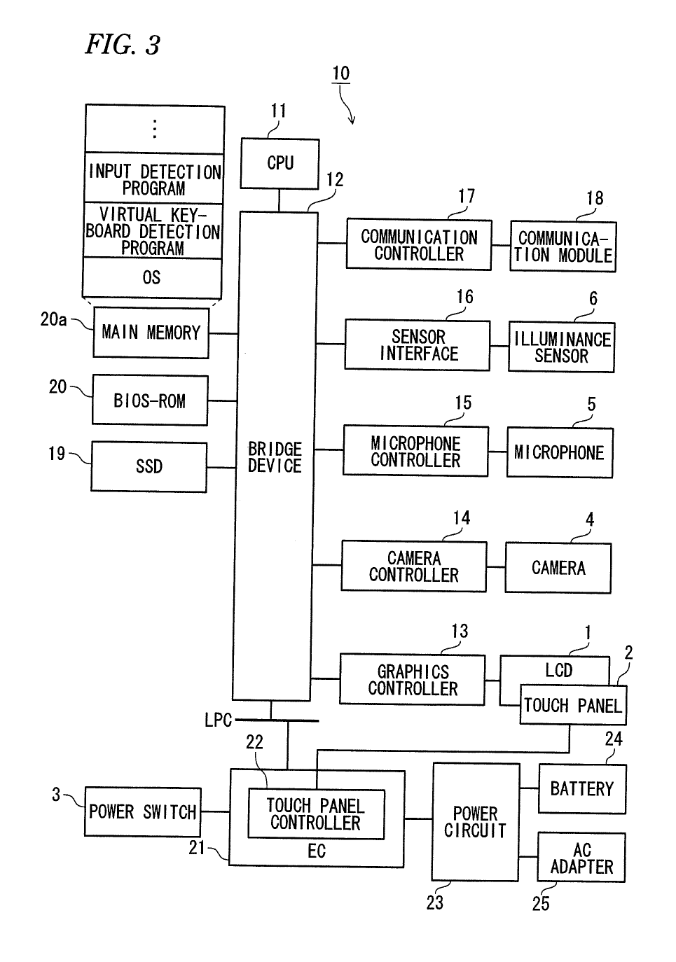

Next, the general configuration of a main part of the information processing apparatus 10 will be described with reference to FIG. 3. As shown in FIG. 3, the information processing apparatus 10 is equipped with a CPU (central processing unit) 11, a bridge device 12, a main memory 20a, a camera controller 14, a microphone controller 15, a sensor interface 16, a communication controller 17, a communication module 18, an SSD (solid-state drive) 19, a BIOS-ROM (basic input/output system-read only memory) 20, an EC (embedded controller) 21, a power circuit 23, a battery 24, and an AC adapter 25.

The CPU 11 may be a processor configured to control the operations of the respective components of the information processing apparatus 10. The CPU 11 runs an operating system (OS), various utility programs, and various application programs that are read into the main memory 20a from the SSD 19. The CPU 11 also runs a BIOS stored in the BIOS-ROM 20. The BIOS is basic programs for hardware control and is.

In this embodiment, the CPU 11 functions as a keyboard detector by running a program for detection of a virtual keyboard 50 (virtual keyboard detection program) that is read into the main memory 20a from the SSD 19. The CPU 11 also functions as the input detecting unit by running a program for detecting inputs to a virtual keyboard 50 (input detection program) that is read into the main memory 20a from the SSD 19.

The bridge device 12 communicates with a graphics controller 13, the camera controller 14, the microphone controller 15, the sensor interface 16, and the communication controller 17.

Furthermore, the bridge device 12 incorporates a memory controller configured to control the main memory 20a. The bridge device 12 also communicates with respective devices on a PCI (peripheral component interconnect) bus (not shown) and respective devices on an LPC (low pin count) bus.

The main memory 20a is a temporary storage area into which the OS and the various programs to be run by the CPU 11 are read.

The graphics controller 13 executes a display process (a graphics calculation process) for drawing video data in a video memory (VRAM) according to a drawing request that is input from the CPU 11 via the bridge device 12. Display data corresponding to a screen image to be displayed on the LCD 1 is stored in the video memory.

The camera controller 14 controls the camera 4 so that the camera 4 captures a subject in its angle of view, in response to a shooting request that is input from the CPU 11 via the bridge device 12. An image captured by the camera 4 is stored in the main memory 20a temporarily, and transferred to and stored in the SSD 19 when necessary.

The microphone controller 15 controls the microphone 5 so that the microphone 5 picks up sound generated around the information processing apparatus 10 according to the directivity of the microphone 5 in response to a sound pickup request that is input from the CPU 11 via the bridge device 12.

The sensor interface 16 is an interface configured to connect the illuminance sensor 6 to the bridge device 12. As described above, the illuminance sensor 6 is a sensor configured to detect brightness therearound and to output the detected brightness in the form of an electrical signal. The electrical signal (hereinafter may be referred to as “light-and-dark information”) indicating the brightness detected by the illuminance sensor 6 is supplied to the CPU 11 via the sensor interface 16 and the bridge device 12.

The CPU 11 controls the luminance of the LCD 1, that is, the luminance of a backlight (not shown) of the LCD 1, based on the light-and-dark information detected by the illuminance sensor 6. For example, based on the light-and-dark information detected by the illuminance sensor 6, the CPU 11 controls the LCD 1 so as to increase the luminance when the ambient brightness is low and to decrease the luminance when the ambient brightness is high.

While the virtual keyboard detection program is being run, the CPU 11 controls the luminance of the LCD 1 based on the light-and-dark information detected by the illuminance sensor 6 and the image captured by the camera 4.

The communication controller 17 controls the communication module 18 according to a communication request that is input from the CPU 11 via the bridge device 12. The communication module 18 wirelessly communicates with an external device having a communication function.

The SSD 19 stores various programs including the virtual keyboard detection program and the input detection program. Also, the SSD 19 stores various kinds of information for use in the respective programs to serve as a database.

The EC 21 powers on or off the information processing apparatus 10 according to a user manipulation of the power switch 3. That is, the EC 21 controls the power circuit 23. Also, the EC 21 is equipped with a touch panel controller 22 configured to control the touch panel 2 which is provided in the LCD 1. The EC 21 operates all the time irrespective of whether the information processing apparatus 10 is powered on or off.

When supplied with external power via the AC adapter 25, the power circuit 23 generates system power to be supplied to the respective components of the information processing apparatus 10 using the external power supplied via the AC adapter 25. Also, when supplied with no external power via the AC adapter 25, the power circuit 23 supplies power to the respective components of the information processing apparatus 10 using the battery 24.

### <Detection of the Virtual Keyboard 50>

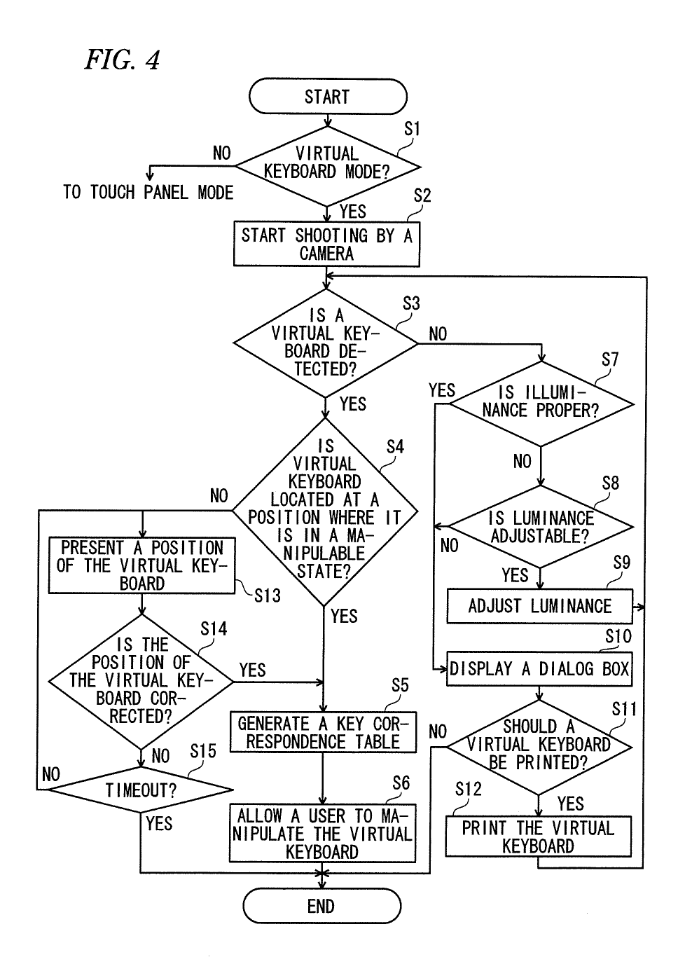

Next, how the virtual keyboard detection program operates when run by the CPU 11 will be described with reference to a flowchart of FIG. 4. It is assumed that before start of running of the virtual keyboard detection program, the CPU 11 is in a touch panel mode in which the CPU 11 operates according to manipulations made through the touch panel 2 of the information processing apparatus 10.

At step S1, the CPU 11 determines, based on an input that is made by a user on the touch panel 2 in the touch panel mode, as to whether to continue the touch panel mode or to make a transition to a virtual keyboard mode in which a virtual keyboard 50 is used.

For example, the CPU 11 causes the LCD 1 to display a dialogue screen (not shown) that prompts a user to select the touch panel mode or the virtual keyboard mode through menu item selection or the like. The user selects the touch panel mode or the virtual keyboard mode through the dialogue screen.

When a current mode is transitioned to the virtual keyboard mode, the CPU 11 proceeds to step S2.

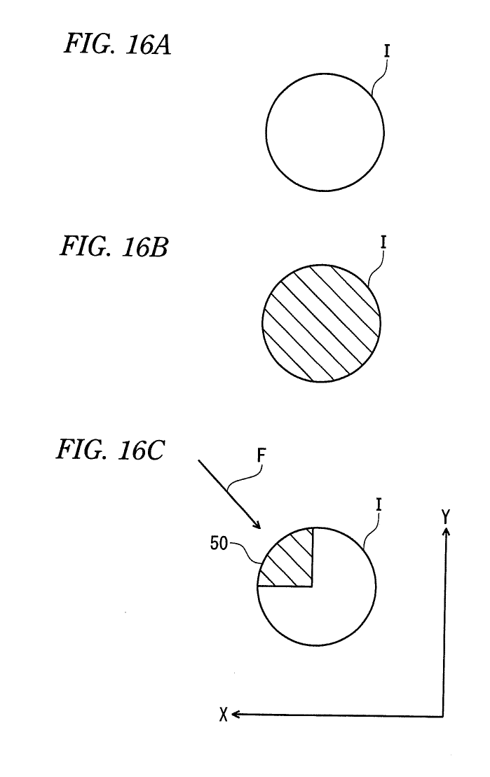

When the current mode is transitioned to the virtual keyboard mode, the CPU 11 GUI-displays an indicator I (by a broken line, for example) on the LCD 1 as shown in FIG. 1. Thus, it is indicated that the information processing apparatus 10 is in the virtual keyboard mode (see FIG. 16A).

As described later, the indicator I has an information presenting function of indicating a position of the virtual keyboard 50 in the image captured by the camera 4.

Upon transition to the virtual keyboard mode, the CPU 11 runs the virtual keyboard detection program, which detects a virtual keyboard 50 and which has been read into the main memory 20a from the SSD 19. If a virtual keyboard 50 is detected, the CPU 11 runs the input detection program for detecting inputs to the virtual keyboard 50. The virtual keyboard detection program will be described later in detail.

At step S2, the CPU 11 controls the camera controller 14 to start shooting by the camera 4. Captured images are stored temporarily in the main memory 20a at predetermined time intervals.

At step S3, the CPU 11 determines as to whether or not a virtual keyboard 50 has been detected, based on a captured image. Basically, the CPU 11 determines as to whether or not a virtual keyboard 50 has been detected, based on whether or not a virtual keyboard 50 exists in the captured image.

More specifically, examples of a method for detecting a virtual keyboard 50 by the CPU 11 include the following two methods.

### (1) First Detection Method: Detect Using Identification Mark

In the first detection method, it is determined as to whether or not a virtual keyboard 50 exists in the captured image, by detecting, from the captured image, an identification mark that is printed on an medium MM on which the virtual keyboard 50 is printed. The identification mark is a mark (figure, character, or the like) for identification of a virtual keyboard 50.

### (2) Second Detection Method: Detect Through Comparison With Reference Image

In the second detection method, it is determined as to whether or not a virtual keyboard 50 exists in the captured image, by comparing the captured image with a reference image (that is stored in advance) of the virtual keyboard 50.

As described above, the first detection method is a method that detects presence of a virtual keyboard 50 indirectly using another information, for example, the identification mark. On the other hand, the second detection method is a method that detects presence of a virtual keyboard 50 directly using a reference image of the virtual keyboard 50. Each of the first detection method and the second detection method will be described below in detail.

### (First Detection Method: Detection Using Identification Mark)

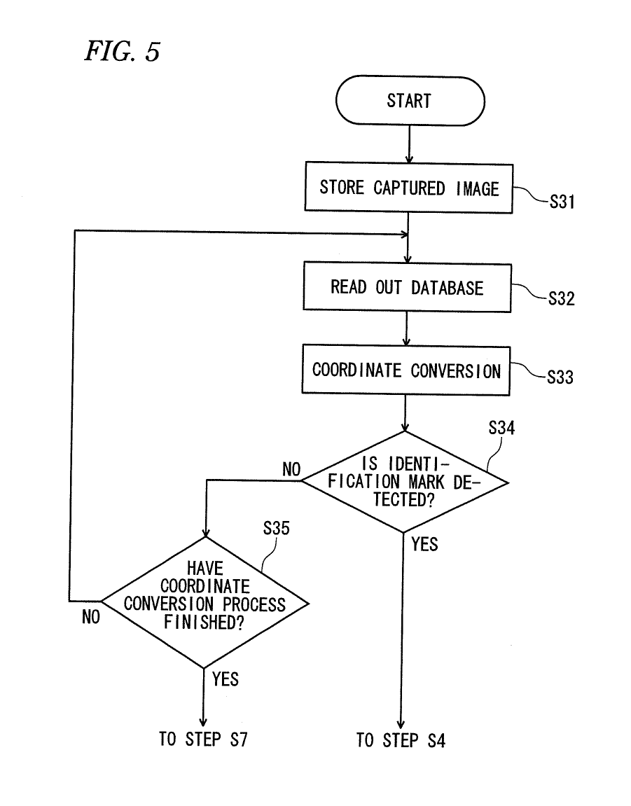

The first detection method will be described below with reference to a flowchart of FIG. 5.

At step S31, the CPU 11 stores the captured image in the main memory 20a.

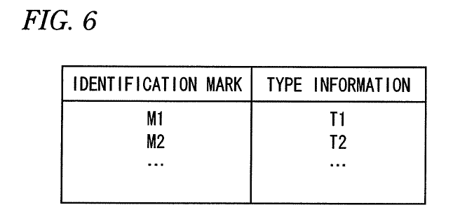

At step S32, the CPU 11 reads, for example, an identification mark database as shown in FIG. 6 from the database stored in the SSD 19.

As shown in FIG. 6, the identification mark database is a database in which identification marks are associated with at least type information, respectively. The type information is information for identification of a type of the corresponding virtual keyboard 50. More specifically, the type information is information for identification of what keyboard the corresponding virtual keyboard 50 is, for example, identification of key arrangement of the corresponding virtual keyboard 50, an overall shape of the corresponding virtual keyboard 50, and the like.

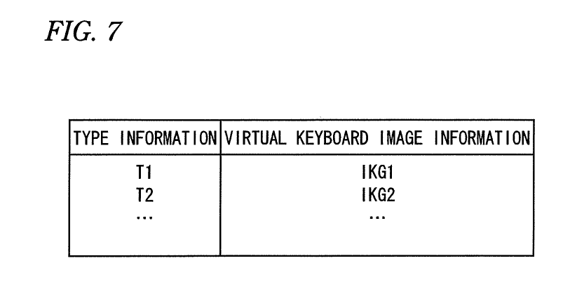

The SSD 19 stores a virtual keyboard image database in which, for example, the type information are associated with virtual keyboard image information which are information of virtual keyboard images, as shown in FIG. 7. As is understood from the above description, if an identification mark is known, virtual keyboard image information of a virtual keyboard 50, that is, a virtual keyboard 50 can be determined uniquely.

As described later in detail, the virtual keyboard image information which is stored in the virtual keyboard image database in association with the type information is used as information of a reference image for identification of a virtual keyboard 50.

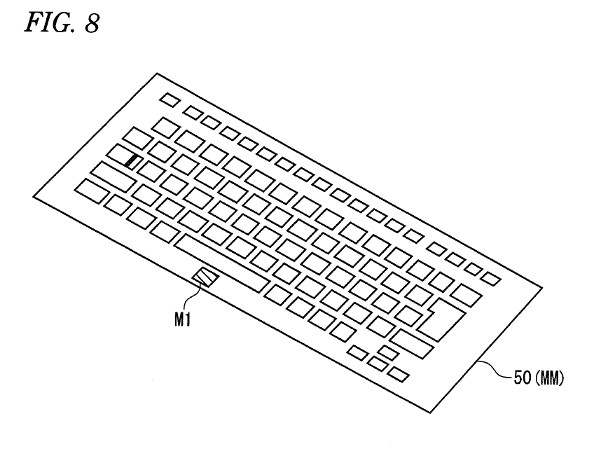

When a virtual keyboard 50 is printed a medium MM, an identification mark may be printed at least one location on a medium MM. FIG. 8 shows an example printing result in which a virtual keyboard 50 and an identification mark. Ml are printed on a medium MM.

Examples of the identification mark include a two-dimensional code. However, the identification mark may be of any information so long as it enables unique identification of a virtual keyboard 50. The probability of success of detection of a virtual keyboard 50 can be increased by printing an identification mark of the virtual keyboard 50 at plural locations on a medium MM.

At step S33, the CPU 11 reads out one of the identification marks (images) stored in the identification mark database and executes a coordinate conversion process for the read-out identification mark using coordinate conversion parameters.

A virtual keyboard 50 is not placed at a fixed position with respect to the camera 4 each time and, instead, is placed each time at a position that is determined, to some extent, arbitrarily at the discretion of a user. Therefore, there might be a case where the identification mark in a captured image cannot be identified using the identification marks stored in the identification mark database, depending on a positional relationship between the camera 4 and the medium MM on which the virtual keyboard 50 is printed. As a result, a situation where a virtual keyboard 50 cannot be detected might occur frequently.

In view of the above, the CPU 11 executes the coordinate conversion process at step S33 to make a shape of the identification mark (image), which is read out from the identification mark database, closer to the shape of the identification mark in the image captured by the camera 4. Thereby, the CPU 11 can detect the virtual keyboard 50, which is printed on the medium MM, from the image captured by the camera 4.

The coordinate conversion process is to cope with a phenomenon that the identification mark on the medium MM is deformed (distorted) according to the positional relationship between the virtual keyboard 50 and the camera 4. That is, sets of the coordinate on the identification mark (image) read out from the identification mark database is converted into sets of the coordinate on the captured image using the positional relationship between the virtual keyboard 50 and the camera 4 as parameters (coordinate conversion parameters). Comparing the coordinate-converted identification mark (image) with the captured image facilitates the detection of the identification mark.

Taking the computation ability of the CPU 11 and other factors into consideration, the coordinate conversion parameters may be set in advance based on an area (in the angle of view of the camera 4) where the virtual keyboard 50 is assumed to be placed. That is, the coordinate conversion parameters may be set in a range of the positional relationship between the virtual keyboard 50 and the camera 4 that corresponds to a practical placement area of the virtual keyboard 50. As a result, the calculation process load of the CPU 11 can be reduced.

At step S34, the CPU 11 determines as to whether or not the identification mark concerned is found in the captured image, by comparing the identification mark, which is coordinate-converted at step S33, with the captured image which is stored in the main memory 20a (detection of an identification mark). If the identification mark concerned is found in the taken image (Yes at step S34), the CPU 11 proceeds to step S4. If not (No at step S34), the CPU 11 proceeds to step S35.

At step S35, the CPU 11 determines as to whether or not all the identification marks stored in the database have been subjected to the coordinate conversion process. If not all the identification marks have been subjected to the coordinate conversion process yet (No at step S35), the CPU 11 returns to step S32. If all the identification marks have been subjected to the coordinate conversion process (Yes at step S35), the CPU 11 proceeds to step S7.

### (Second Detection Method: Detection Through Comparison With Reference Image)

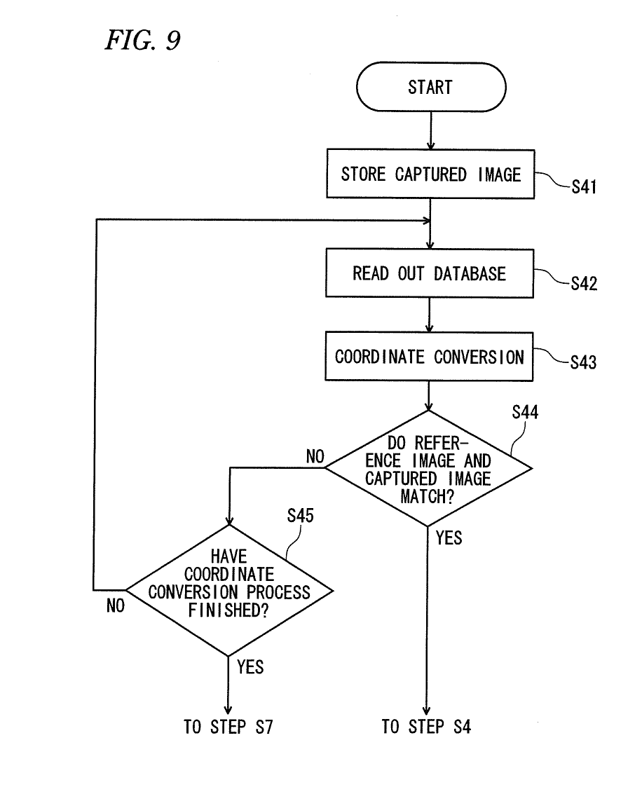

Next, the second detection method will be described below with reference to a flowchart of FIG. 9.

At step S41, the CPU 11 stores a captured image in the main memory 20a.

At step S42, the CPU 11 reads out, for example, the above-described virtual keyboard image database shown in FIG. 7 from the database stored in the SSD 19.

As mentioned above, the virtual keyboard image information, which are stored in the virtual keyboard image database in association with the type information, can be used as information indicating a reference image for identification of a virtual keyboard 50.

At step S43, the CPU 11 reads out one of the virtual keyboard image information stored in the virtual keyboard image database and executes a coordinate conversion process for the read-out virtual keyboard image information, using coordinate conversion parameters.

As mentioned above, a virtual keyboard 50 is not placed at a fixed position with respect to the camera 4 each time and, instead, is placed each time at a position that is determined, to some extent, arbitrarily at the discretion of a user. Therefore, the virtual keyboard 50 in a captured image may be much different from the corresponding virtual keyboard image information (reference image) depending on the positional relationship between the camera 4 and the medium MM on which the virtual keyboard 50 is printed. In such a case, the virtual keyboard 50 might not be detected.

In view of the above, the CPU 11 executes the coordinate conversion process at step S43 to make a shape of the reference image closer to the shape of the virtual keyboard 50 in the image captured by the camera 4. Thereby, the CPU 11 can detect the virtual keyboard 50, which is printed on the medium MM, from the image captured by the camera 4.

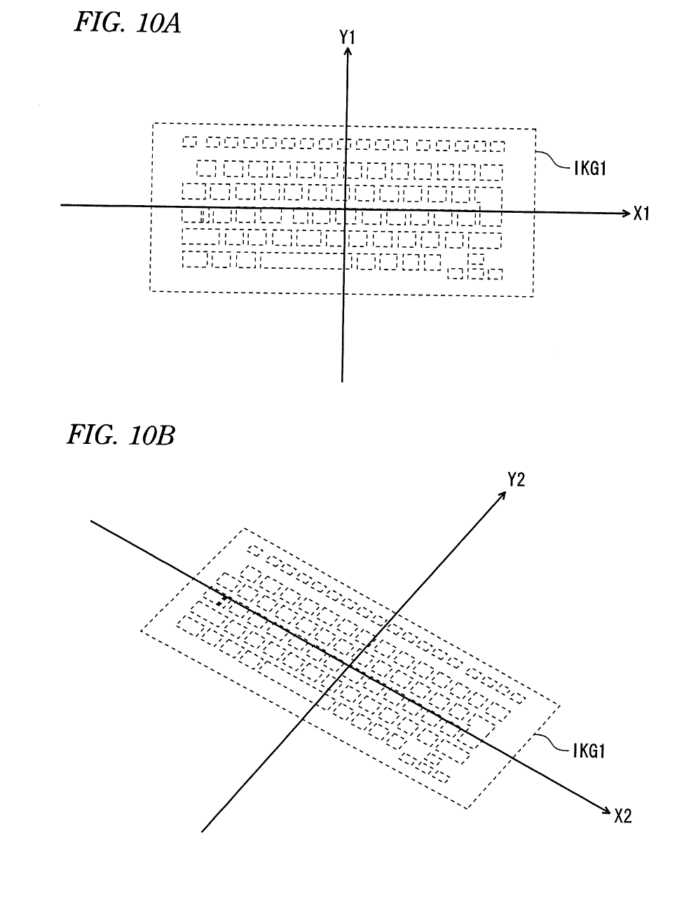

It is assumed that a virtual keyboard 50 is placed relative to the information processing apparatus 10 in the manner shown in FIG. 1 and that virtual keyboard image information (reference image) IKG1, which is stored in the virtual keyboard image database shown in FIG. 7, is image information as drawn by broken lines in FIG. 10A. Symbols X1 and Y1 denote coordinate axes.

It is also assumed that the virtual keyboard image information IKG1 is converted into a reference image having converted coordinate axes X2 and Y2 (see FIG. 10B) by the coordinate conversion using certain coordinate conversion parameters. The CPU 11 generates new virtual keyboard image information (new reference image) by coordinate-converting the virtual keyboard image information (reference image), which is stored in advance.

Taking the computation ability of the CPU 11 and other factors into consideration, the coordinate conversion parameters are set in advance based on an area (in the angle of view of the camera 4) where the virtual keyboard 50 is assumed to be placed. That is, the coordinate conversion parameters are set in a range of the positional relationship between the virtual keyboard 50 and the camera 4 that corresponds to a practical placement area of the virtual keyboard 50. As a result, the calculation processing load of the CPU 11 can be reduced.

At step S44, the CPU 11 determines as to whether or not the virtual keyboard 50 concerned is found in the captured image by comparing the reference image, which is obtained by the coordinate conversion at step S43, with the captured image which is stored in the main memory 20a.

It is not necessary that the captured image contain the entire reference image. The CPU 11 determines that the virtual keyboard 50 concerned exists in the captured image if parts of images are identical, that is, if a part of the reference image matches a part of the captured image.

The camera 4 captures a virtual keyboard 50, and a captured image is generated. It is assumed that the CPU 11 generates virtual keyboard information (converted image) as shown in FIG. 10B through the coordinate conversion. The CPU 11 determines that the virtual keyboard 50 concerned is found in the captured image if the reference image shown in FIG. 10B at least partially matches the captured image.

If the reference image concerned is found in the captured image (Yes at step S44), the CPU 11 proceeds to step S4. If not (No at step S44), the CPU 11 proceeds to step S45.

At step S45, the CPU 11 determines as to whether or not all the virtual keyboard image information stored in the database have been subjected to the coordinate conversion. If not all the virtual keyboard image information have been subjected to the coordinate conversion yet (No at step S45), the CPU 11 returns to step S42. If all the virtual keyboard image information have been subjected to the coordinate conversion (Yes at step S45), the CPU 11 proceeds to step S7.

Which of the first detection method and the second detection method is used is determined depending on the virtual keyboard detection program installed in the information processing apparatus 10. One of the two methods may be used in a fixed manner, or the virtual keyboard detection program may allow a user to select one of the two methods.

Referring back to FIG. 4, if a virtual keyboard 50 is detected by one of the two detection methods (Yes at step S3), the CPU 11 proceeds to step S4. If not (No at step S3), the CPU 11 proceeds to step S7.

### (Process to be Executed When Virtual Keyboard 50 is not Detected)

If a virtual keyboard 5 is not detected at step S3 (No at step S3), at step S7 the CPU 11 determines as to whether or not the illuminance of light with which the virtual keyboard 50 as a subject of the camera 4 is illuminated is proper.

The virtual keyboard 50 is illuminated with natural light or light produced by indoor illumination lamps. However, it may not be easy to control such light. Therefore, in this embodiment, the illuminance around the camera 4 is detected by the illuminance sensor 6, and the luminance of the backlight of the LCD 1 is adjusted according to the detected illuminance.

If determining based on information that is supplied from the illuminance sensor 6 that the illuminance of the light with which the virtual keyboard 50 is illuminated is not proper, the CPU 11 adjusts the luminance of the backlight of the LCD 1 (step S9) in a range in which the luminance is adjustable (step S8). That is, when a virtual keyboard 50 is not detected, the CPU 11 functions as a luminance adjustor configured to increase the luminance on the LCD 1 (display). Upon execution of the luminance adjustment, the CPU 11 returns to step S3.

If determining at step S7 that the illuminance of the light is proper or determining at step S8 that the luminance is not adjustable, the CPU 11 proceeds to step S10.

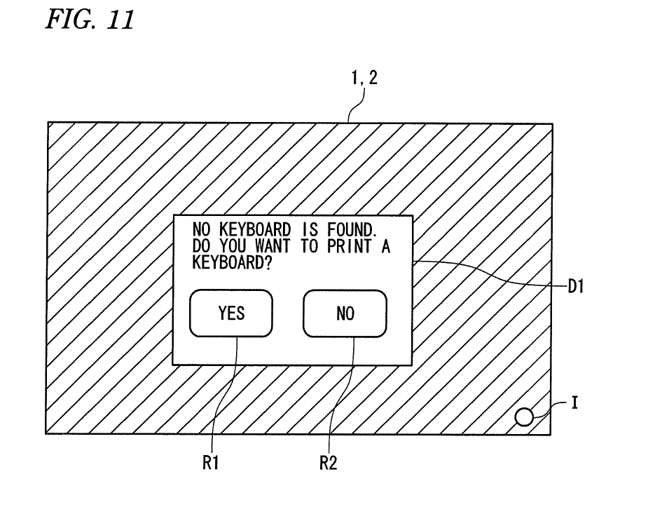

If it is impossible to adjust the luminance by the backlight of the LCD 1, at step S10 the CPU 11 performs control so as to display on the LCD a dialog box that prompts a user to print a virtual keyboard 50. For example, as shown in FIG. 11, the CPU 11 causes the LCD 1 to display a dialog box D1 containing a message “No keyboard is found. Do you want to print a keyboard?” which is information that prompts a user to print a virtual keyboard.

Radio buttons R1 and R2 marked with “yes” and “no,” respectively, which enable a user to input an answer to the question as to whether or not to print a virtual keyboard 50 are also displayed in the dialog box D1 (step S10).

If at step S11 the user determines in response that a virtual keyboard 50 should be printed, the CPU 11 reads out the virtual keyboard image database shown in FIG. 7 from the database stored in the SSD 19. The CPU 11 may cause the LCD 1 to display a list of information such as images of the virtual keyboards 50 and types of the virtual keyboards 50 based on the read-out virtual keyboard image database, to thereby prompt the user to select a desired virtual keyboard 50.

Then, at step S12, the CPU 11 specifies the virtual keyboard 50 selected by the user and issues a command to print the specified virtual keyboard 50 on a medium MM. In response to the print execution command from the CPU 11, the communication controller 17 and the communication module 18 are controlled and connected to an external printing device with which communication can be established. Thus, the specified virtual keyboard 50 is printed on a medium MM.

As described above, even if a virtual keyboard 50 is not detected, a user can easily print a desired virtual keyboard 50.

### (Detection of Non-Inputtable State)

At step S4, the CPU 11 determines as to whether or not the virtual keyboard 50 existing in the captured image is in a manipulable state in which when the virtual keyboard 50 is manipulated by a user, the CPU 11 can recognize that the virtual keyboard 50 is manipulated.

Basically, if all of the keys of the virtual keyboard 50 exist in the captured image, the CPU 11 can image-recognize as to whether or not each key has been manipulated. That is, the “manipulable state” of the virtual keyboard 50 is a state where the positions of the respective keys are recognized by the CPU 11 of the information processing apparatus 10. If the virtual keyboard 50 is not in the manipulable state, it is determined that the virtual keyboard 50 is in a non-inputtable state.

If the virtual keyboard 50 is in the manipulable state, the CPU 11 proceeds to step S5. If the virtual keyboard 50 is in the non-inputtable state, the CPU 11 proceeds to step S13.

Printing boundary marks on a medium MM together with a virtual keyboard 50 makes it possible to determine as to whether or not the printed virtual keyboard 50 is in the non-inputtable state.

The boundary marks are marks which indicate a boundary of an area where keys required to perform an input manipulation for a virtual keyboard 50 are printed, that is, a boundary between an inputtable area and an non-inputtable area.

The boundary marks are stored in the database and may be any marks. The CPU 11 determines as to whether or not the virtual keyboard 50 is in the non-inputtable state by detecting the boundary marks from the captured image. Therefore, the boundary marks are arranged on a medium MM on which the virtual keyboard 50 is printed, so as to surround a key-printed area, that is, an area that can specify the key-inputtable area.

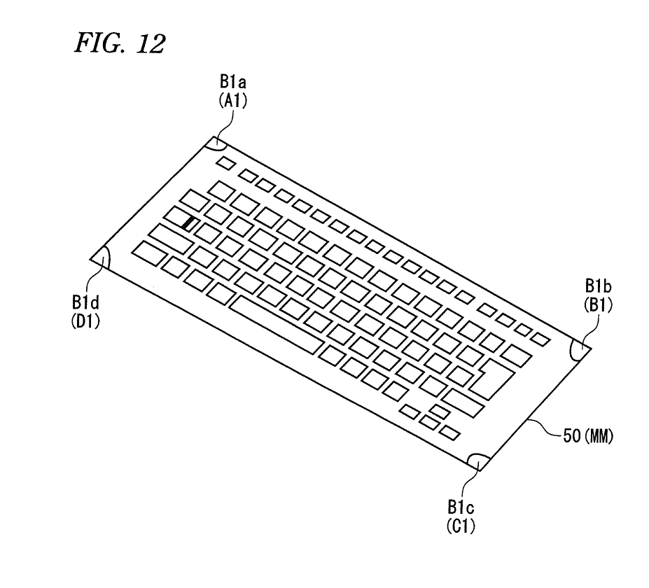

For example, it is assumed that the virtual keyboard 50 is printed on the medium MM in a manner shown in FIG. 12. Positions that surround the key-inputtable area of the virtual keyboard 50 may be the four corners A1, B1, C1, and D1 of the medium MM. The key-inputtable area of the virtual keyboard 50 can be surrounded by boundary marks B1a, B1b, B1c, and B1d which are printed at the four respective corners A1, B1, C1, and D1.

If only a part of the key-inputtable area is detected, it can be detected that the virtual keyboard 50 is in the non-inputtable state. In the example of FIG. 12, if only three of the four boundary marks are detected, it can be determined that the virtual keyboard 50 is in the non-inputtable state.

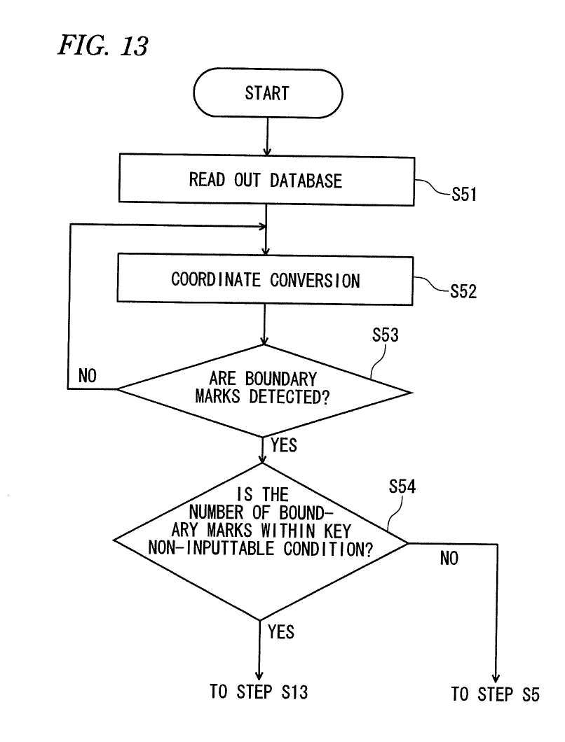

A method for detecting that a virtual keyboard 50 is in the non-inputtable state but not in the manipulable state will be described with reference to a flowchart of FIG. 13.

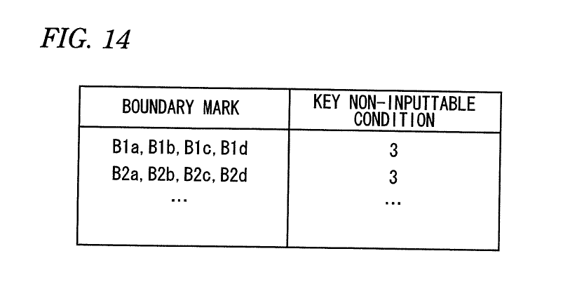

At step S51, the CPU 11 reads out, for example, a boundary mark database as shown in FIG. 14 from the database stored in the SSD 19.

As shown in FIG. 14, the boundary mark database is a database in which boundary marks are associated with at least key non-inputtable conditions. As described above, the boundary marks are marks that are printed so as to surround a key-inputtable area. That is, it is assumed that the boundary marks themselves have information indicating positional relationships with a key-inputtable area. The “key non-inputtable condition” indicates a maximum number of boundary marks that leads to determination that the virtual keyboard 50 is in the non-inputtable state.

For example, let consider the case where that the boundary marks are printed at the four corners of the virtual keyboard 50 as shown in FIG. 12. If all the four boundary marks are detected, that is, if the key-inputtable area is fully included in the captured image, it can be determined that the virtual keyboard 50 is in the inputtable state. On the other hand, if only three or less boundary marks are detected, that is, only a part of the key-inputtable area is included in the captured image, it can be determined that the virtual keyboard 50 is in the non-inputtable state.

At step S52, the CPU 11 reads out boundary marks contained in the boundary mark database and executes a coordinate conversion process on the read-out the boundary marks using the coordinate conversion parameters.

Since the CPU 11 has already performed the coordinate conversion process at the previous step (e.g., step S33 of the first detection method or step S43 of the second detection method), the CPU 11 performs the coordinate conversion process on the boundary marks using the values of the coordinate conversion parameters which have been used in the previous step. Therefore, the coordinate conversion process is not described here in detail.

At step S53, the CPU 11 determines as to whether or not corresponding boundary marks exist in the captured image, which is stored in the main memory 20a, by comparing the boundary marks which are subjected to the coordinate conversion process at step S52 with the captured image. If corresponding boundary marks are found in the captured image, the CPU 11 proceeds to step S54. If not, the CPU 11 returns to step S52.

At step S54, the CPU 11 refers to the boundary mark database in response to that the boundary marks are detected.

The CPU 11 determines, based on the key non-inputtable condition which is stored in association with the detected boundary marks, as to whether or not the number of detected boundary marks exceeds the number which is set as the key non-inputtable condition.

If the number of detected boundary marks exceeds the number which is set as the key non-inputtable condition (No at step S54), the CPU 11 determines that a key-inputtable area has been specified and that the virtual keyboard 50 is in the manipulable state. Then, the CPU 11 proceeds to step S5.

On the other hand, if the number of detected boundary marks does not exceed the number which is set as the key non-inputtable condition (Yes at step S54), the CPU 11 determines that a key-inputtable area has not been identified and that the virtual keyboard 50 is in the non-inputtable state. Then, the CPU 11 proceeds to step S13. As such, the CPU 11 serves as an non-inputtable state detector configured to detect that a virtual keyboard is in the non-inputtable state.

In the above description, it is assumed that the boundary marks are printed at the four corners of the virtual keyboard 50. However, the number of boundary marks may be three because the position of the virtual keyboard 50 can be determined if its three or more points (boundary marks) are specified.

As described above with reference to the flowchart of FIG. 13, whether the virtual keyboard 50 is in the manipulable state, that is, not in the non-inputtable state, can be determined using the boundary marks. However, as described below, whether the virtual keyboard 50 is not in the non-inputtable state can be determined without using the boundary marks.

For example, as in the above-described second detection method, the image captured by the camera 4 is compared with the reference image. Whether the virtual keyboard 50 is in the manipulable state or the non-inputtable state can be determined by detecting whether or not an image of the inputtable area of the virtual keyboard 50 exists in the captured image.

As described above, where the second detection method is employed, whether or not the virtual keyboard 50 is in the non-inputtable state can be detected either by using the boundary marks or by comparing the captured image with the reference image.

Also, the identification mark(s) used in the first detection method may serve as the boundary mark(s), and vice versa. That is, the boundary marks which have the function of indicating the inputtable area of the virtual keyboard 50 may also be given the function of the identification mark(s) which are used in the first detection method to identify the virtual keyboard 50. Since this makes it possible to reduce the amount of information to be printed on the medium MM, the appearance thereof can be improved.

Referring back to the flowchart of FIG. 4, if the virtual keyboard 50 is in the manipulable state (i.e., not in the non-inputtable state; Yes at step S4), at step S5 the CPU 11 generates a key correspondence table (which is a table for specifying, in the captured image, respective positions of the plural keys of the virtual keyboard 50).

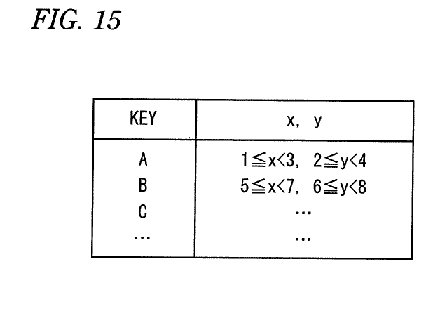

When key input is performed for the virtual keyboard 50, the thus-generated key correspondence table is used to detect an input state of the manipulated key of the virtual keyboard 50. The key correspondence table may be of any type so long as it enables detection of an input state of each key. In this embodiment, it is assumed that as shown in FIG. 15, the key correspondence table is a table in which each key is associated with X and Y coordinate ranges (X and Y coordinate axes are set for the captured image). Using the key correspondence table, when change occurs between images of the virtual keyboard 50 in captured images, the CPU 11 can determine what key is manipulated based on coordinate ranges corresponding to the change.

The values of the key correspondence table, which is generated by the virtual keyboard detection program, represent an initial state that corresponds to an initial position to be used in detecting position deviation of the virtual keyboard 50 (which will be described later).

At step S6, the CPU 11 allows the user to manipulate the virtual keyboard 50 in response to the fact that the virtual keyboard 50 is detected and is in the manipulable state. Thus, the user can input information to the information processing apparatus 10 through the virtual keyboard 50.

### (Position Correction of Virtual Keyboard 50)

If the virtual keyboard 50 is in the non-inputtable state, at step S13 the CPU 11 present, to the user, a position at which the virtual keyboard 50 exists in the image captured by the camera 4.

This presentation can be done using the indicator I. As mentioned above, the indicator I has the information presenting function of indicating the position of the virtual keyboard 50 in the image captured by the camera 4.

FIGS. 16A to 16C show an example of display patterns of the indicator I. For example, when a transition is made to the virtual keyboard mode in the flowchart of FIG. 4, the indicator I is displayed as shown in FIG. 16A.

In the flowchart of FIG. 4, if the virtual keyboard 50 is located at such a position as to be in the manipulable state, the indicator I is highlighted in its entirety as shown in FIG. 16B. In this case, the virtual keyboard 50 exists in the image captured by the camera 4. The indicator I in this state allows the user to visually understand at a glance as to how the virtual keyboard 50 is recognized by the information processing apparatus 10.

In contrast, the indicator I shown in FIG. 16C indicates that the virtual keyboard 50 is located at a top-left position in the image (defined in the XY plane) captured by the camera 4. In this case, the virtual keyboard 50 is detected but is in the non-inputtable state.

Therefore, the user is to correct the position of the virtual keyboard 50 in a direction F shown in FIG. 16C while referencing to the indicator I. That is, the indicator I shown in FIG. 16C indicates information of prompting the user to correct the position of the virtual keyboard 50.

If determining at step S14 that the position of the virtual keyboard 50 is corrected (Yes at step S14), the CPU 11 proceeds to step S5 because the non-inputtable state of the virtual keyboard 50 is solved and because the virtual keyboard 50 is in the manipulable state. If determining at step S14 that the position of the virtual keyboard 50 is corrected (No at step S14), the CPU 11 proceeds to step S15.

At step S15, the CPU 11 determines as to whether a timeout of the attempt to detect the virtual keyboard 50 occurs. If the timeout has not occurred yet, the CPU 11 returns to step S13. If the timeout occurs, the CPU 11 terminates the virtual keyboard mode.

As described above, the CPU 11 detects the virtual keyboard 50 by reading the virtual keyboard detection program from the SSD 19 and running it. If the virtual keyboard 50 is not detected, the CPU 11 can cause printing of a desired virtual keyboard 50. A user is not required to carry a real keyboard together with the information processing apparatus 10, and can still input information substantially in the same manner as when he or she uses a real keyboard.

### <Detection of Inputs Through Virtual Keyboard 50>

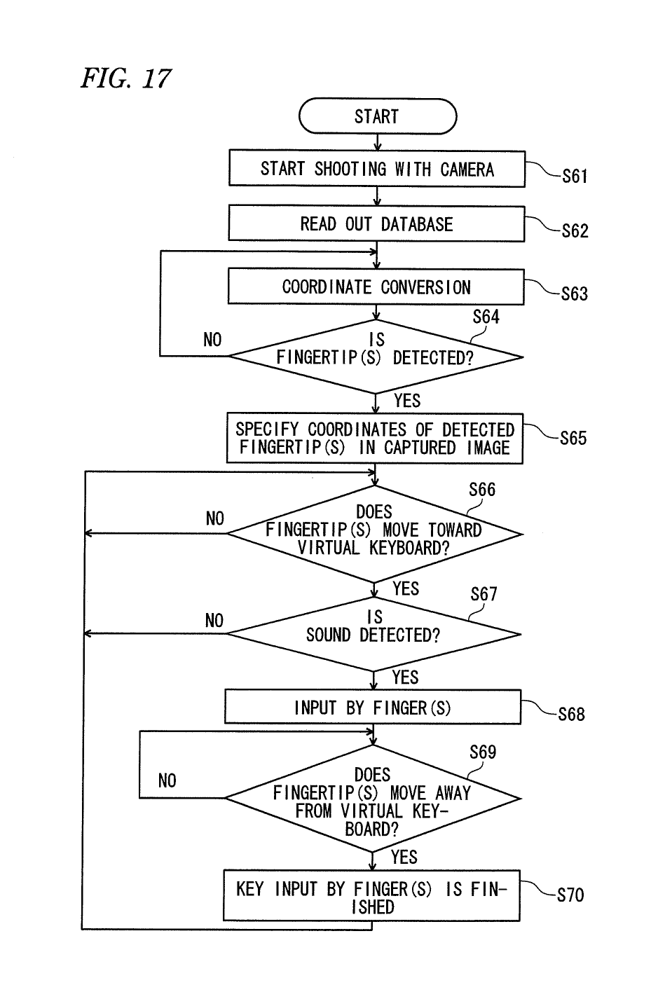

Next, how the input detection program operates when run by the CPU 11 will be described with reference to a flowchart of FIG. 17. The CPU 11 runs the input detection program after running the above-described virtual keyboard detection program and permitting manipulation with the virtual keyboard 50.

At step S61, the CPU 11 controls the camera 4 to cause it to start shooting. Captured images are stored temporarily in the main memory 20a at prescribed time intervals.

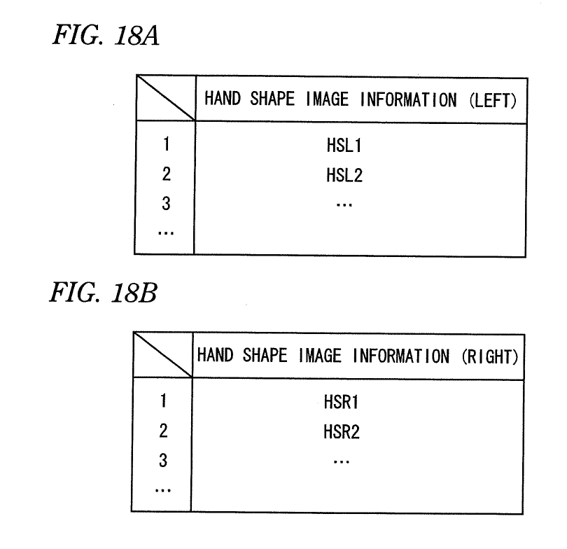

At step S62, the CPU 11 reads out, for example, a hand shape image database (left) and a hand shape image database (right) as shown in FIGS. 18A and 18B from the database stored in the SSD 19.

FIGS. 18A and 18B show separate databases which contain sets of image information of general human left and right hand shapes, respectively. More specifically, each database contains a set of hand shape image information indicating hand shapes that are expected to be obtained when hands are placed over a virtual keyboard 50 and shot by the camera 4. Each database is a database which is produced and stored taking into consideration various hand shapes that are expected when a user manipulates keys of a virtual keyboard 50, for example, even whether a user uses five fingers or only one finger of each hand.

Not only the hand shape but also particularly the finger tip shapes relate to key input. Constructing each database in such a manner that it is mainly formed by image information of finger tip shapes makes it possible to reduce the amount of information and to thereby save the memory resource and reduce the calculation processing load.

In the following, for convenience of description, the databases shown in FIGS. 18A and 18B may be collectively referred to as hand shape image databases.

The sets of hand shape image information contained in the respective hand shape image databases are used as reference images for identifying a fingertip that manipulates a key of the virtual keyboard 50.

At step S63, the CPU 11 performs coordinate conversion on the hand shape image information contained in each of the hand shape image databases using the coordinate conversion parameters that have been determined by the virtual keyboard detection program. This makes it possible to detect a fingertip(s) in the same coordinate plane as was used in detecting the virtual keyboard 50.

At step S64, the CPU 11 determines as to whether or not a fingertip(s) are placed over the virtual keyboard 50 based on the captured image(s) stored in the main memory 20a and the hand shape image information which is subjected to the coordinate conversion. This fingertip detection process is performed for all the hand shape image information contained in each of the hand shape image databases. Therefore, all fingertips placed over the information processing apparatus 10 can be detected.

If a fingertip(s) are detected, the CPU 11 proceeds to step S64. If not, the CPU 11 returns to step S63.

At step S65, the CPU 11 determines coordinates (positions) of all the detected fingertip(s) in the captured image(s). Thus, the CPU 11 functions as a position detector configured to detect a position(s) of a fingertip(s) of a manipulator.

The SSD 19 stores the key correspondence table as shown in FIG. 15 because the virtual keyboard detection program was run. In this manner, the CPU 11 can recognize the position(s) of the fingertip(s) that were detected at step S65 and the position(s) of key(s) of the virtual keyboard 50 in one-to-one correspondence.

Therefore, inputs of the user to the virtual keyboard 50 can be detected indirectly by detecting in what direction(s) the position(s) of the fingertip(s) move in the captured images.

At step S66, the CPU 11 determines as to whether or not the position(s) of the fingertip(s) in the captured images move toward the virtual keyboard 50. That is, the CPU 11 functions as a fingertip movement detector configured to detect movement(s) of a fingertip(s) of a manipulator. If the position(s) of the fingertip(s) in the captured images move, it is highly probable that the user starts input to the keys of the virtual keyboard 50.

At step S67, the CPU 11 determines as to whether or not a sound having a prescribed frequency is detected by the microphone 5 so as to be timed with the movement(s) of the fingertip(s) in the captured images.

For example, a sound having the prescribed frequency is a sound to be detected when the medium MM is tapped by a finger. The probability of detection can be increased by also preparing sounds having such frequencies as to be detected when the medium MM is tapped at positions where the medium MM is to be placed such as a desk or knees. Such sounds are picked up and sampled in advance and stored in the SSD 19.

If a sound having the prescribed frequency is detected, the CPU 11 proceeds to step S68. If not, the CPU 11 returns to step S66.

At step S68, based on the movement direction(s) of the fingertip(s) and the detection of the inputting sound, the CPU 11 determines that input to the virtual keyboard 50 by the finger(s) of the user starts. That is, the CPU 11 functions as a start detector configured to detect a start of the input to the virtual keyboard 50.

However, with regard to the detection of the start of the input to the virtual keyboard 50, the detection of the inputting sound (step S67) may be omitted. In this case, if a movement(s) of the fingertip(s) toward the virtual keyboard 50 is detected, the CPU 11 determines that input to the virtual keyboard 50 starts.

At step S69, the CPU 11 determines as to whether or not the positions of the fingertips in the captured images move in such a direction as to go away from the virtual keyboard 50, i.e., in the direction that is opposite to the direction toward the virtual keyboard 50. When the fingertips in the captured images move in this manner, it means that the user finishes the manipulation of the keys of the virtual keyboard 50.

At step S70, based on the movement direction of the fingertips, the CPU 11 determines that the input to the virtual keyboard 50 by the fingers of the user ends. That is, the CPU 11 functions as an end detector configured to detect the end of the input to the virtual keyboard 50.

As described above, the CPU 11 of the information processing apparatus 10 can detect user's inputs to the virtual keyboard 50 by reading out and running the input detection program stored in the SSD 19. A user is not required to carry a real keyboard together with the information processing apparatus 10, and can still input information substantially in the same manner as when he or she uses a real keyboard.

### (Detection of Position Deviation)

Incidentally, while running the input detection program, the CPU 11 detects a position deviation of the virtual keyboard 50 from the position detected by the virtual keyboard detection program.

It is not always the case that the medium MM on which the virtual keyboard 50 is printed is kept fixed. For example, it is expected that the position of the medium MM is deviated by a wind or the like or is deviated by key manipulations.

To deal with such a position deviation, the CPU 11 also runs a position deviation detection program while running the input detection program.

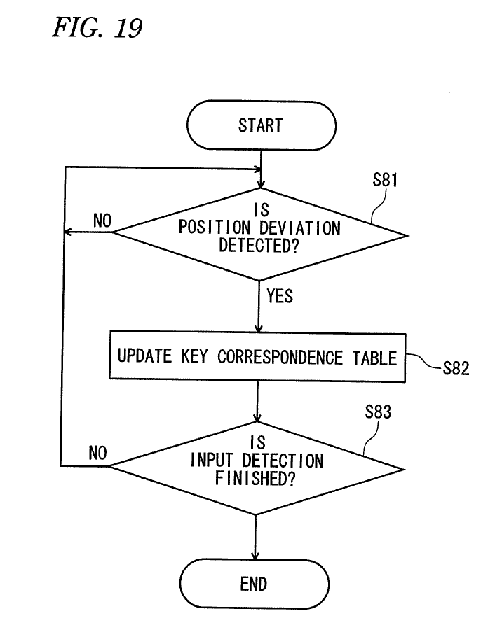

How the position deviation detection program operates when run by the CPU 11 will be described with reference to a flowchart of FIG. 19.

At step S81, the CPU 11 determines as to whether or not the position of the virtual keyboard 50 has deviated based on the captured images.

For example, where no boundary marks are printed on the medium MM, the CPU 11 may attempt to detect a position deviation of the entire virtual keyboard 50 in the captured images. Where boundary marks are printed on the medium MM, the CPU 11 may attempt to detect a position deviation based on whether or not the boundary marks have moved. That is, the CPU 11 functions as a mark movement detector configured to detect movement of the boundary marks.

At step S4, it is determined whether or not the virtual keyboard 50 is in the manipulable state, using the four boundary marks. To set an initial position of the virtual keyboard 50, it is necessary to identify three or more points (boundary marks). In contrast, to determine as to whether or not only two boundary marks have moved is sufficient to determine as to whether or not a position deviation occurs. The reason why a post-movement position can be determined using a smaller number of points (boundary marks) would be that a movement of the virtual keyboard 50 from the initial position usually occurs on the surface (plane) on which the medium MM is placed.

If a position deviation is detected, at step S82 the CPU 11 updates the values of the key correspondence table, which is stored in the SSD 19.

At step S83, the CPU 11 determines as to whether or not the input detection program ends. If determining that the input detection program ends, the CPU 11 also terminates the position deviation detection program. If not, the CPU 11 returns to step S81.

As described above, the CPU 11 updates the key correspondence table each time position deviation of the virtual keyboard 50, which is printed on the medium MM, is detected. As a result, key inputs to the virtual keyboard 50 by the user can be always well detected.

### (Modifications)

As described above, in the information processing apparatus 10 according to the embodiment, the single camera 4 is provided as an imaging device configured to capture (shoot) a subject. Alternatively, imaging devices may be provided at plural locations such as positions C1 and C2 as indicated by broken lines in FIG. 1.

Where the information processing apparatus 10 is provided with the plural imaging devices, the CPU 11 can recognize a subject three-dimensionally by performing image processing on captured images. Therefore, the space recognition ability can be made higher than that in the case where the single camera 4 is provided as an imaging device. Thereby, the input detection program detects user's inputs to a virtual keyboard 50 more reliably.

### (Virtual Touch Pad)

The above description is directed to the case where the virtual keyboard 50 is used as an input device to be manipulated by a user. However, the embodiment is not limited thereto. The input device to be manipulated by the user may be a virtual touch pad which does not have particular manipulation members such as keys, that is, a virtual touch pad. That is, no keys or the like are printed on the virtual touch pad at all.

In the case where the virtual touch pad is used in place of the virtual keyboard 50, a process of detecting the virtual touch pad, a process of detecting input to the virtual touch pad, and the like are substantially the same as the processes in the case of the virtual keyboard 50. Therefore, description thereon will be omitted here.

The CPU 11 of the information processing apparatus 10 can detect user's inputs to the virtual touch pad by reading out and running an input detection program stored in the SSD 19. As a result, the user is not required to carry an external input device together with the information processing apparatus 10, and can still enjoy the same level of convenience as when he or she uses the external input device.

Although the embodiments have been described above, the embodiments are just examples and are not intended to restrict the scope of the invention. The embodiments may be practiced in other various forms. A part of each embodiment may be omitted, replaced by other elements, or changed in various manners without departing from the spirit and scope of the invention. Such modifications are also included in the invention as claimed and its equivalents.

What is claimed is:

1. An information processing apparatus comprising:
an imaging module;
a keyboard detector configured to detect a virtual keyboard based on an image captured by the imaging module;
a first input detector configured to detect an input to the virtual keyboard based on the captured image; and
a display configured to display information corresponding to the input detected by the first input detector.

2. The apparatus of claim 1, wherein the virtual keyboard includes a keyboard image that is printed on a medium.

3. The apparatus of claim 2, wherein an identification mark for identification of the virtual keyboard is printed on the medium, the apparatus further comprising:
a storage configured to store information indicating the identification mark, wherein
the keyboard detector is configured to detect the virtual keyboard by comparing the captured image with the stored information indicating the identification mark.

4. The apparatus of claim 3, wherein:
the identification mark indicates a type of the virtual keyboard, and
the keyboard detector is configured to detect the type of the virtual keyboard by comparing the captured image with the stored information indicating the identification mark.

5. The apparatus of claim 2, further comprising:
a storage configured to store a reference image of the virtual keyboard, wherein the keyboard detector is configured to detect the virtual keyboard by comparing the captured image with the reference image.

6. The apparatus of claim 5, wherein
the storage is configured to store a plurality of reference images which are different from each other, and
the keyboard detector is configured to detect a type of the virtual keyboard by comparing the captured image with the plurality of reference images.

7. The apparatus of claim 1, further comprising:
a luminance adjustor configured to increase a luminance of the display when the keyboard detector has not detected the virtual keyboard.

8. The apparatus of claim 7, further comprising:
a brightness detector configured to detect brightness around the imaging module, wherein the luminance adjustor increases the luminance of the display according to a detection result of the brightness detector when the keyboard detector has not detected the virtual keyboard.

9. The apparatus of claim 7, wherein the display displays information for prompting a user to print the virtual keyboard when the keyboard detector has not detected the virtual keyboard.

10. The apparatus of claim 2, wherein three or more boundary marks are printed on the medium along a boundary of an inputtable area of the virtual keyboard, the apparatus further comprising:
a storage configured to store information indicating the boundary marks; and
a non-inputtable state detector configured to detect as to whether or not the virtual keyboard is in a non-inputtable state, based on the captured image and the stored information indicating the boundary marks, wherein
when the non-inputtable state detector detects that the virtual keyboard is in the non-inputtable state, the display displays information for prompting a user to correct a position of the virtual keyboard.

11. The apparatus of claim 10, further comprising:
a table generator configured to generate a table indicating positions of plural respective keys of the virtual keyboard based on a detection result of the non-inputtable state detector, wherein
the storage is configured to stores the generated table.

12. The apparatus of claim 10, further comprising:
a mark movement detector configured to detect movements of any of the boundary marks; and
a table updater configured to update the stored table based on a detection result of the mark movement detector.

13. The apparatus of claim 10, wherein:
the first input detector includes
a position detector configured to detect a position of a fingertip of a manipulator based on the captured image, and
a fingertip movement detector configured to detect a movement of the fingertip based on the positions detected by the position detector,
the first input detector is configured to detect a manipulated key based on the position of the fingertip and positions of plural respective keys of the virtual keyboard at a time when the fingertip movement detector detects the movement of the fingertip.

14. The apparatus of claim 13, wherein the first input detector further includes a start detector configured to detect start of the input to the virtual keyboard, by detecting that the fingertip moves in a first direction toward the virtual keyboard.

15. The apparatus of claim 13, wherein the first input detector further includes an end detector configured to detect end of the input to the virtual keyboard by detecting that the fingertip moves in a second direction away from the virtual keyboard.

16. The apparatus of claim 13, wherein
the imaging module includes a plurality of imaging devices, and
the position detector detects the position of the fingertip based on a plurality of images captured by the plurality of imaging devices.

17. The apparatus of claim 13, further comprising:
a sound detector configured to detect a sound, wherein
the first input detector detects a manipulated key based on the position of the fingertip at a time when the fingertip movement detector detects that the fingertip moves and the sound detector detects the sound.

18. The apparatus of claim 1, further comprising:
a touch pad detector configured to detect a virtual touch pad based on the captured image; and
a second input detector configured to detect input to the virtual touch pad based on the captured image.

19. An information processing method comprising:
capturing an image;
detecting a virtual keyboard based on the captured image;
detecting an input to the virtual keyboard based on the captured image; and
displaying information corresponding to the detected input.

20. A computer readable storage medium storing a program that causes a processor to execute information processing, the information processing comprising:
capturing an image;
detecting a virtual keyboard based on the captured image;
detecting an input to the virtual keyboard based on the captured image; and
displaying information corresponding to the detected input.
